(19) United States
(12) Patent Application Publication
(10) Pub. No.: US 2011/0132476 A1
(43) Pub. Date: Jun. 9, 2011

(54) HYDRAULIC VALVE DEVICE

(76) Inventor: Winfried Rüb, Waldshut-Tiengen (DE)

(21) Appl. No.: 12/734,286

(22) PCT Filed: Nov. 13, 2008
(86) PCT No.: PCT/EP2008/009578

§ 371 Date: Apr. 22, 2010

(30) Foreign Application Priority Data
Nov. 14, 2007 (DE) 10 2007 054 135.1

(51) Int. Cl. F16K 15/00

(52) U.S. Cl. 137/511

(57) ABSTRACT

The invention relates to a hydraulic valve device having a fluid connector arrangement (10) comprising at least one pressure supply connector P for providing a pump pressure, a return flow connector R,—a section load sensing connector LS, two control connectors P′_{A} and P′_{B}, and two utility connectors A, B for providing a utility connection pressure, and having a displaceable control device (18) for at least partially controlling the connector arrangement (10), wherein a pressure balance (14) is connected upstream of the control device (18), and wherein the pressure balance (14) comprises a check valve (56). Because a fluid-conducting connection to the reverse flow connector R may be produced by means of the pressure balance (14) and the pressure balance (14) interacts with the check valve (56) such that, at least during control processes of the pressure balance (14) relating to the pressure supply connector P, the check valve (56) is held in the open position thereof such that fluid flowing back from one of the control connectors P′_{A}, P′_{B} flows in the direction of the return flow connector R controlled by the pressure balance (14), the control options are broadened for the valve device according to the invention.

The invention relates to a hydraulic valve device with a fluid connector arrangement comprising at least the following:
a pressure supply connector P for making available a pump pressure,
a return flow connector R,
a section load sensing connector LS,
two control connectors P′_{A} and P′_{B} and
two utility connectors A, B for making available a utility connection pressure
   and with a displaceable control means for at least partial triggering of individual connectors of the connector arrangement, a pressure compensator being connected upstream from the control means, and the pressure compensator having a check valve.

DE 603 04 663 T2 discloses a hydraulic valve arrangement with a supply connector arrangement having a high pressure connector P and a low pressure connector T, a utility connector arrangement comprising two working or utility connectors A, B that can be connected to a consumer, a directional valve and a compensation valve that is located between the directional valve and the supply connector arrangement P, T, and whose pressure output is connected to the pressure input of the directional valve, the compensation valve having a relief output, which can be connected to the pressure output, and a valve element in the form of a spool, which can be moved out of an initial position in opposite directions, and which can be exposed to pressure on one side in the load sensing line and to the force of a spring and on the opposite side can be exposed to the pressure at the pressure output, the valve element, when moved in one direction, performing a pressure control function, and, when moved in the opposite direction, performing a pressure relief function, the spool having a longitudinal channel which is connected via a transverse bore to the pressure output and ends in a first pressure chamber, and the longitudinal channel extending beyond the transverse bore and being connectable via a closable opening to a second pressure chamber in which a relief pressure prevails.

A pressure compensator with independent leak relief is connected upstream from the displaceable control means, this relief output being connected to a load sensing line which is connected to the directional valve.

With this known solution, it is possible to counteract so-called parasitic pressure propagation, as can occur especially at higher pressures and which can lead to lifting of loads in an unintended and dangerous manner. In this connection, the safety valves which have been used in the past can, however, likewise be subject to leaks and can even contribute to formation of parasitic pressure propagation.

EP 1 500 825 A2 discloses a directional control valve for triggering a consumer with two valve spools located coaxially to one another, by way of which two utility connectors A, B which are connected to the consumer can be connected to the pressure supply connector P or a return flow connector R, and which are pretensioned in a base position, between the valve spools there being a spring means with a spring element. Because the spring means has a limit for establishing the maximum effective length of the spring element in the known solution, the valve spools can be moved apart from one another only up to a certain amount by “capturing” the spring element which is located in the middle, so that the valve spools in the base position are essentially exposed to their respective outer spring force by way of the pretensioning and assume a defined base position; this, accordingly, increases the operating reliability of the known solution. In this solution, a pressure compensator is connected upstream from the control means in the hydraulic fluid direction.

DE 10 2005 033 222 A1 discloses a so-called LUDV valve arrangement in which a directional control valve forms an inlet metering orifice to which an individual pressure compensator is connected downstream. By way of the LUDV valve arrangement, a hydraulic consumer which is connected to two consumer or utility connectors of the control arrangement is triggered. To set the quick traverse, two pressure spaces of the consumer can be connected to one another and to a source of hydraulic fluid. In order to prevent “sagging” of the consumer, this connection of the two consumer connectors takes place by way of the flow path of the hydraulic fluid in which there is a check valve. By way of the directional control valve itself, only the connection to one of the consumer connectors is opened, the connection of the other consumer connector to the source of hydraulic fluid and/or the former consumer connector is possible in quick traverse only via the flow path of the hydraulic fluid and the opened check valve. Unintentional movement of a hydraulic consumer in the quick traverse position of the valve arrangement is prevented in this way.

The generic DE 42 34 037 C2 discloses a hydraulic valve device, in particular for mobile machinery, with a housing block, with a directional control valve with a metering orifice, with a pressure compensator which, together with the metering orifice, controls the flow of hydraulic fluid, with a control piston which can be moved in the bore of the housing block and has a pressure surface which can be pressurized by the load pressure, and with a load signal valve whose valve body is located in the load signal valve housing that is separate relative to the control piston of the pressure compensator and can likewise be pressurized by the load pressure. In that, according to the known solution, the load signal valve housing is inserted into the bore of the housing block and with the control piston of the pressure compensator borders the pressure chamber which can be pressurized by the load pressure, the inserted load signal valve can be produced with little effort and it can be easily replaced, so that a construction, which is well-suited for so-called monoblocks, is implemented.

A conventional pressure compensator is connected upstream from the control means with the corresponding structure, the pressure compensator having a check valve which, with the pressure compensator opened, enables a return stroke function such that the respective utility connection pressure cannot drop below a pump pressure that is briefly too low, so that it is ensured that when a hydraulic consumer circuit is started up against “standing loads” dictated by hydraulic consumers which are connected to the utility connectors, dangerous lowering of the load is reliably avoided, especially if the pump pressure should be briefly too low for triggering. During these control processes of the pressure compensator, the check valve is kept permanently in its closed position.

Proceeding from this prior art, the object of the invention is to devise a hydraulic valve device solution which has an upstream pressure compensator which, together with the overall valve construction, has a compact structure and which otherwise in operation is not highly susceptible to vibration and is thus reliable and increases the control possibilities with the valve device. This object is achieved by a valve device with the features of claim 1 in its entirety.

In that, according to the characterizing part of claim 1, a fluid-conducting connection to the return flow connector R can be established by means of the pressure compensator, and in that the pressure compensator interacts with the check valve such that at least in control processes of the pressure compensator relating to the pressure supply connector P, the check valve is kept in one of its open positions such that fluid which is flowing back from one of the control connectors P′_{A}, P′_{B}, controlled by the pressure compensator drains toward the return flow connector R, as is shown in the most similar prior art, it is ensured on the one hand that the return stroke function starts with the pressure compensator opened and thus the respective utility connection pressure cannot drop below a pump pressure which is briefly too low so that when the hydraulic consumer circuit is started up against “standing loads”, due to hydraulic consumers which are connected to the utility connectors A, B, hazardous lowering of the load is reliably avoided, in particular, if the pump pressure should be briefly too low for triggering.

On the other hand, with this configuration according to the invention, not only within the illustrated scope is control possible in the inflow direction to the respective utility connector A, B, but also pressure control for the medium which is flowing back from one of the control connectors P′_{A} or P′_{B} to the tank by way of the indicated return flow connector R. In this way, for example, in so-called bearing pressure control an unintentional pressure rise is avoided; this enhances the control onset range with the valve device in this respect. With this bearing pressure control, a load to be triggered, for example, in the form of a mowing head or the like, can follow a ground contour in a defined manner with a defined ground contact force. This application constitutes only one possible use and the solution according to the invention can be used wherever it is especially a matter of keeping differential forces on the implements constant.

Advantageous connection of the return flow connector to prevent an unintentional pressure rise when hydraulic fluid returns from the respective consumer utility connector also contributes to a sufficient flow cross section to the tank being able to be opened by way of the pertinent configuration; this simplifies control. When the fluid is flowing back, another check valve can therefore also be used because the pressure compensator in the connecting line to the return flow connector likewise advantageously prevents the closing stroke of the check valve. As a result of the added return stroke function within the pressure compensator, it is very stable in operation and is therefore not susceptible to vibration; this enables defined continuing triggering of the consumer in the hydraulic circuit in both directions. Moreover, the pressure compensator has a compact structure; overall, this benefits a compact, space-saving overall valve construction.

Since certain fluid connecting lines can also be triggered by means of the return stroke function, they need not be provided separately within the valve construction; this furthermore helps save installation space. As a result of the desired modular system with modular individual components, the valve device according to the invention is also inexpensive to produce and otherwise reliable in use.

The upstream pressure compensator within the valve device is preferably a component of a proportional load sensing directional control valve with pump and return flow connectors on the valve spool axis. Due to the switching logic of the spool axis there are always at least one pressure supply connector P and two return flow connectors R there or, as an alternative, two pressure supply connectors P, P_{ST} and one return flow connector R. In the following description, due to other advantages in the valve and modular construction, here the version with two pressure supply connectors P, P_{ST} and one return flow connector R is detailed. The corresponding conditions, however, also apply accordingly to the other possible version.

The valve device according to the invention is detailed below using one exemplary embodiment as shown in the drawings. The figures are schematic and not to scale.

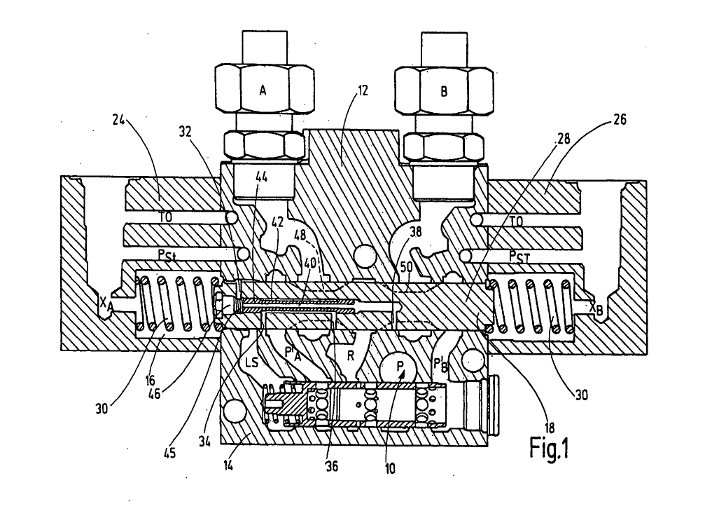

FIG. 1 shows, in the form of a longitudinal section, one exemplary embodiment of the hydraulic valve device, for the sake of simplicity the return stroke function for the pressure compensator not being shown in FIG. 1;

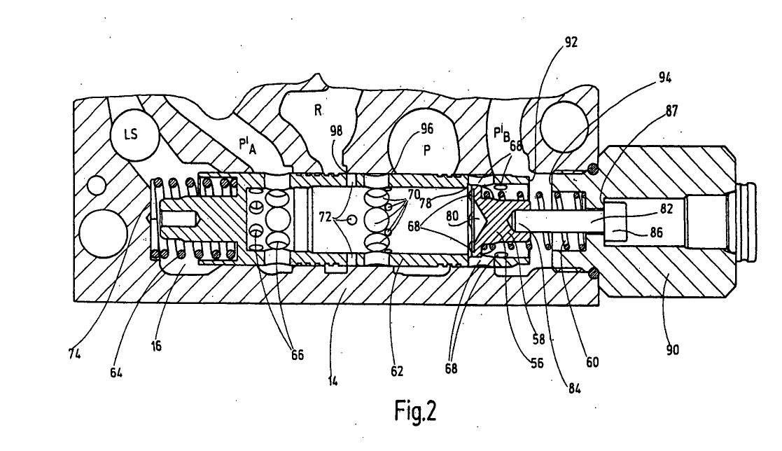

FIG. 2 shows a representation which has been enlarged relative to FIG. 1, solely with respect to the pressure compensator with the return stroke function depicted, using a check valve.

FIG. 1 shows a fluid connector arrangement designated as a whole as 10. This fluid connector arrangement 10 has a pressure supply connector P, a return flow connector R, a section load sensing connector LS, two control connectors P′_{A}, P′_{B}, and two utility connectors A, B. The indicated fluid connectors LS, P′_{A}, R, P and P′_{B}, A and B are accommodated in a control housing 12, viewed in the direction of looking at FIG. 1, the lower end of the control housing 12 being provided with a pressure compensator 14 which is connected upstream to the connectors LS, P′_{A}, R, P and P′_{B} and triggers them accordingly.

With the respective pressure compensator 14 connected upstream, the so-called quantitative cutoff function is implemented by LS pressure limitation in the spring chamber 16 of the pressure compensator, quantitative cutoff making sense, for example, when the steering cylinder of a hydraulic working circuit, which cylinder is not detailed, connected to the utility connectors A, B, is on the limit stop and the inflow amount in this respect is to be cut off to prevent overloads.

A control means 18 of the valve device as such is triggered conventionally and therefore is not detailed further by conventional pilot valves which for the sake of simplicity are shown in FIG. 1 only to the extent that their respectively assignable pilot housings 24, 26 are addressed. On the output side the two pilot valves for the control means 18 deliver two control pressures X_{A} and X_{B} which act in opposite directions. Furthermore, on the respective pilot valve a pump control pressure P_{ST} then acts and forms in this respect one other P connector at a time within the version presented here. Furthermore, a tank connector line T₀ is likewise connected to the respective pilot valve.

The indicated control means 18 has a valve spool 28 which can be moved horizontally when viewed in the direction of looking at FIG. 1 and which in FIG. 1 is shown in its undeflected middle or neutral position. This pertinent neutral position of the valve spool 28 is still supported by two spring storage devices that are made as compression springs 30 and are integrated in the respectively assignable spring chamber in the pilot housings 24, 26. This structure is conventional in the corresponding hydraulic valve devices so that it will not be detailed here.

The control means 18 with the valve spools 28 is provided with load reporting connectors 32, 34 and with load sensing connectors 36, 38 which are interconnected in pairs to carry fluid. The first load reporting connector 32 is connected to the second load sensing connector 38 to carry fluid and the second load reporting connector 34 is fluid-connected to the first load sensing connector 36. The indicated reporting connectors and sensing connectors are integrated into the valve spools 28 in the form of transverse radial bores and depending on which axial position of movement the valve spool 28 assumes, the indicated connectors 32, 34, 36 and 38 are connected to the respectively assignable connectors of the fluid connector arrangement 10 to carry fluid or to block.

To produce the fluid-carrying connection between the load reporting and load sensing connectors 32, 36; 34, 38 which can be assigned to one another in pairs, connecting channels 40, 42 located within the valve spool 28 are used. Here, one of the connecting channels 40 is made as a so-called middle channel which, in the neutral position of the control means 18 shown in FIG. 1, with its axial length covers the region between the section load sensing connector LS and the utility connector B. In this respect, the middle channel, viewed in the direction of looking at FIG. 1, is located on the left side of the valve spool 28 and runs in the form of an attached blind bore along the longitudinal axis of the valve spool 28. In a parallel arrangement thereto, another connecting channel 42 is at least one annular longitudinal channel which in turn in the neutral position of the control means 18 with its axial overall length covers at least the region between the control connector P′_{A} and the utility connector A. The load reporting and load sensing connectors 32, 36; 34, 38 are each designed as radially running bores in the valve spool 28.

For producing the channel routing, the middle channel 40 is bordered by an insertion sleeve 44 which, at least partially along its outside periphery located in a definable middle region, with the inside wall of the valve spool 28 in this region borders the annular longitudinal channel 42 which accordingly can be formed also from a plurality of individual channels (not shown) which are located concentrically to the middle channel 40. The axial length of the insert sleeve 44 extends, as shown in FIG. 1, between a first load reporting connector 32 and a constricted offset site between the first load sensing connector 36 and the second load sensing connector 38 at the height of the return flow connector R. While the insert sleeve 44 with its end, which is the right end when viewed in the direction of looking at FIG. 1 is supported at the indicated constriction within the longitudinal bore of the valve spool 28, the opposite other free end in the region of the first load reporting connector 32 is rested on a compression spring 45 which extends, in this respect, between a sealing stopper 46 and the free end of the sleeve and keeps the insertion sleeve 44 in its position with definable pretensioning. Longitudinal tolerances which may be present can be equalized in the system of the insertion sleeve 44 to the valve spool 28 by way of this arrangement.

As FIG. 1 furthermore shows, the valve spool 28 along its outer periphery has two control channels 48, 50 which are oriented in the longitudinal direction and which in the neutral position of the control means 18 each discharge into the utility connector A and the utility connector B. In this respect, in the illustrated neutral position of the valve spool 28, the load sensing bore 36 emerges under the housing wall between the utility connector A and the return flow connector R.

Overall, the illustrated hydraulic valve device forms a so-called LS directional control valve with an upstream pressure compensator 14. These valve devices are used essentially to protect parts of the hydraulic circuit, for which there can be, in addition, a pressure limitation valve which is not shown and the load sensing portion LS is adjusted relative to LSₘₐₓ, preferably, by means of selector valve (not shown). The hydraulic valve device in terms of overall length has a short valve axis configuration with fewer annular channels compared to known solutions. With the upstream pressure compensator 14, the already described function of quantitative cutoff by LS pressure limitation in the spring chamber 16 of the pressure compensator 14 is possible.

At this point, the pressure compensator 14 will be detailed below using FIG. 2 in terms of its inventive configuration, in FIG. 2 the return stroke function of the pressure compensator 14 also being shown; the latter has been omitted in FIG. 1 for the sake of simplicity. Otherwise, FIG. 2 corresponds to the lower half of FIG. 1 which, when viewed in the direction of looking at FIG. 1, underneath the control means 18 has a pressure compensator 14 which is held in the same control housing 12 of the overall valve device.

To perform the return stroke function, the pressure compensator 14 has a check valve 56 whose return stroke function begins with the pressure compensator opened and ensures that the respective utility connector pressure on the utility connector A or B cannot drop below a pump pressure which is briefly too low; this will be detailed below. As shown in FIG. 2, the check valve 56 with its return stroke function acts on the control connector P′_{B}; but other configurations are also conceivable, for example, in which, in the reversed operating arrangement, the check valve 56 then acts on the control connector P′_{A} or on both sides on the two control connectors P′_{A} and P′_{B}. The check valve 56 has a valve body 58 which is supported on a valve spring 60 that is designed as a compression spring. Viewed in the direction of looking at FIG. 2, the valve spring 60 tries to push the valve body 58 to the left in order in this way to keep it in contact with parts of the control piston 62 of the pressure compensator 14. This control piston 62 is supported on its other end against a control spring 64 which is likewise designed as a compression spring and whose spring characteristic is made stiffer than the characteristic of the valve spring 60. If the valve body 58 of the check valve 56 as shown in FIG. 2 is in contact with the control piston 62, both the control spring 64 and also the valve spring 60 act on the corresponding control piston 62 in the opposite direction.

The control piston 62 has passage openings which are divided into individual function groups, the first group 66 being assigned to the control connector P′_{A} and the second group 68 to the control connector P′_{B}. The third group 70 is assigned to the pressure supply connector P and the fourth group 72, which is designed as relief bores, is assigned to the return flow connector R. Except for the fourth group 72, the other groups 66, 68, 70 are formed from two adjacently located passage rows with different bore diameters; this helps facilitate the control function for the pressure compensator 14.

The control spring 62 is moreover supported with its other free end which is facing away from the check valve 56 on wall parts 74 of the pressure compensator housing which in this regard is a component of the control housing 12. Otherwise, the control spring 64 is held in the spring chamber 16 of the control housing 12, and the spring chamber 16 is connected by the medium to the section load sensing connector LS which can be made with a pressure limitation function that is not detailed, for example, using a pressure limitation valve which is not detailed.

As FIG. 2 furthermore shows, in the control function of the control piston 62 the valve body 58 with its left free end clears at least in part the second group 68 on the passage openings in the direction of the control connector P′_{B}. In the blocked position of the check valve 56, this second group 68 and therefore the indicated fluid path are blocked by the valve body 58 which here is supported with its free face-side end on a shoulder 78 of the control piston 62. Furthermore, the valve body 58 on its end side facing in the direction of the interior of the control piston 62 has a depression 80, preferably in the form of a cone which is oriented to the inside. The maximum stroke of the valve body 58 of the check valve 56 shown in FIG. 2 is bordered in this respect in its closing direction by a limitation means 82 which has a stop screw which, as shown, with its free screw end 84 engages a recess of the valve body 58 and the screw head 86 pushes against the boundary wall 87 of a screw-in part 90 which is screwed into the pressure compensator housing to form a seal and which, in the case of repair and installation, after its removal enables access to the inside parts of the pressure compensator 14. If the pressure compensator is depressurized compared to the control position shown in FIG. 2, the control spring 64 moves the control piston 62 fully to the right as viewed in the direction of looking at FIG. 2 and the right free end 92 of the control piston 62 then strikes against the adjacent end 94 of the screw-in part 90.

The pressure compensator 14, accordingly, has a first pressure output following P′_{A} and a second pressure output P′_{B} for supply of the valve spool 28 of the control means 18. In this respect, the two pressure outputs following P′_{A} and P′_{B} can be connected to one another without further additional lines by the pressure compensator 14 itself to equalize pressure; this helps save installation space. In this respect, the connection of the two indicated pressure outputs following P′_{A} and P′_{B} takes place through the free middle space in the control piston 62 and the first group 66 of fluid passages to the pressure output following P′_{A} and in the form of a second group 68 to the pressure output following P′_{B}. The supply connector P of the pressure compensator 14 is located, viewed in the longitudinal direction, therefore between the two pressure outputs following P′_{A} and P′_{B} formed by the aforementioned control connectors. Furthermore, the pressure compensator 14 has an additional return flow connector R which is located between the pressure supply connector P and the control spring 64.

When the control piston 62 moves against the control spring 64, first the pressure supply connector P is closed by the third group 70 moving away at passage sites, and, upon further movement to the left, the return flow connector R is opened by the fourth group 72 at passage openings. When the pressure compensator 14 is in its opened position, as already described, it pushes against the screw-in part 90 so that the check valve 56 can assume its closed position. When the pressure compensator 14 is being controlled with a position near the P control edge 96 or the R control edge 98, the check valve 56 conversely cannot close so that the oil running back can drain from the control connector P′_{B} to the return flow connector R. If the valve body 58 has a depression 80, this yields a high pulsed force in jet deflection of the fluid within the hollow control piston 62, from which a large opening stroke for the check valve 56 results with a small pressure loss.

The pressure compensator solution according to the invention will be detailed below using a description of its operation. As already described, in the depressurized state, the control spring 64 of the pressure compensator 14 preloads the control piston 62 up to striking the screw-in part 90 of the control housing 12. The pressure supply connector P is then connected to the third group 70 at the passage openings to carry fluid to the interior of the control piston 62 and, in this respect, to the control connectors P′_{A} and P′_{B} which form the pressure outputs here. The return flow connector R is blocked in doing so. If, at this point, in the neutral position of the valve spool 28 the hydraulic supply pump (not shown) is turned on, hydraulic fluid flows into the control connectors P′_{A} and P′_{B} of the pressure compensator 14. In the process, the pressure in the pressure compensator 14 rises and the resulting compressive force pushes the control piston 62 against the control spring 64 until the P control edge 96 closes. If now highly pressurized hydraulic fluid furthermore penetrates into the pressure compensator 14 due to gap leakage, the control piston 62 continues to move against the control spring 64 until the R control edge opens and the unwanted overpressure decreases until the working pressure in the control connectors P′_{A} and P′_{B} keeps the control pressure of the control spring 64 in equilibrium.

Using the example of a slope mower with a mowing head, which mower is not detailed, bearing pressure control with the hydraulic valve device will now be detailed below. First, the valve spool 28, for example, is moved into the “lift” position by way of the utility connector B and a LS pressure limitation valve which is not detailed is set to its maximum value. The lifting cylinder then moves the mowing head up as far as the stop of the hydraulic working cylinder which is not detailed. Assuming the lifting pressure is less than 50 bar and the assigned LS pressure limitation valve is set to 80 bar, the mowing head drops under its own weight because the pressure compensator 14 on its control connectors P′_{A} and P′_{B} now can only apply a value of 80 bar plus the spring force of the pressure compensator 14. The valve spool 28 is furthermore in the “lift” position and the hydraulic fluid flows from the working cylinder to the utility connector B and then to the control connector P′_{B} and from there to the opened return flow connector R; this is shown in the control position in FIG. 2.

The mowing head then continues to drop onto the ground and lies there with a differential force (=ground contact force) of 150 bar minus the 80 bar+spring force. At an applied spring force of 5 bar then a ground contact force accordingly of 65 bar is active. During mowing, the mowing head is pulled over the ground contour. When it is pulled over an elevation, the mowing head is equally raised, the hydraulic fluid being removed from the control connector P′_{B}. Therefore, the pressure on the control connector P′_{B} drops and the control piston 62 moves into the opening position and allows the hydraulic fluid from the pressure supply connector P to flow in until equilibrium of forces on the pressure compensator 14 is again achieved.

When the mowing head is pulled through a depression, the mowing head then drops and forces the hydraulic fluid into the control connector P′_{B}. There, the pressure rises and the control piston 62 moves against the control spring 64. The return flow connector R is opened and the hydraulic fluid drains out until again equilibrium of forces on the control piston 62 has occurred. The valve body 58 of the check valve 56 can hinder the backflow only until the control piston 62 has more or less closed the P control edge 96. If the control piston 62 continues to move against the control spring 64, the valve body 58 is kept in its position by the described limitation means 82, that is to say, it remains stationary, and a backflow cross section opens.

The check valve 56 in the pressure compensator 14 therefore prevents the load from falling back into the pressure supply connector P. If, for example, the mowing head with a weight load corresponding to 150 bar continues to be run up from a stopped position, the following operating situation takes place. The valve spool 28 is deflected out of the neutral position of the pressure system and the load of 150 bar is, on the one hand, reported to the pressure compensator 14 and, on the other, to a pressure control system which is not shown (pump controller or rotating pressure compensator). The build-up of pump pressure can last a few tenths of a second. During this short time interval, the control piston 62 under the influence of the reported 150 bar on the spring side has run up to its stop and thus has opened the supply connector P to the maximum degree. Then the load pressure of 150 bar has been carried through to the pressure output P′_{B} of the pressure compensator 14 through the open valve spool 28. The control piston 62, however, remains in the completely open position since on both of its end sides the same pressure acts and the spring force produces an excess of force to maintain the open position. The check valve 56 is closed here until the pump pressure has risen to more than 150 bar and lifting—travel can begin. In this respect, it is precluded with certainty that the respective utility connector pressure cannot drop below a pump pressure that is briefly too low with the result that the load drops unintentionally and the displaced amount of fluid is expelled into the pressure supply connector P in the reverse direction; this otherwise would entail a high, dangerous torque.

In summary, it can therefore be stated that with the valve solution according to the invention an impermissibly high dynamic pressure (P′_{A} and ′_{B}) cannot build up in front of the measuring orifice in the neutral position of the valve spool 28 due to potential relief into the return flow connector R. Furthermore, pressure control in the two flow directions, that is to say, from and to the consumer A or B, is enabled. In addition, radial jet routing is good on the respective control edge through radial transverse bores within the hollow control piston 62, implemented by the groups 66, 68, 70, and 72 on the fluid passage openings in the control piston 62. Thus, small disruptive flow forces in the axial direction parallel to the respective deflection direction of the control piston 62 occur only conditionally.

One important aspect of the solution according to the invention is also that the described pressure compensator has a connection to the tank return flow which can be formed by the return flow connector R. By means of this configuration a sufficient cross section to the tank can be opened with the result that the medium which is flowing back can be routed to the tank (pressure control) and not only in the outflow direction to the utility connector is control possible. The integrated check valve saves installation space and in its optional version with maximum closing stroke (screw head) it is a guarantee of pressure control which enables backflow from the respective utility connector to the pressure compensator and to the tank connector. In the solution according to the invention, the pressure compensator travels into the tank connector and the check valve seat in this control position can no longer be reached. The circumstance that the return flow connector R within the illustrated connection sites of FIG. 1 assumes a middle central position is especially important here.

1. A hydraulic valve device with a fluid connector arrangement (10) comprising at least the following:
a pressure supply connector P for making available a pump pressure,
a return flow connector R,
a section load sensing connector LS,
two control connectors P′_{A} and P′_{B} and
two utility connectors A, B for making available a utility connection pressure
and with a displaceable control means (18) for at least partially triggering individual connectors of the connector arrangement (10), a pressure compensator (14) being connected upstream from the control means (18), and the pressure compensator (14) having a check valve (56), characterized in that by means of the pressure compensator (14), a fluid-conducting connection to the return flow connector R can be established and that the pressure compensator (14) interacts with the check valve (56) such that at least in control processes of the pressure compensator (14) relating to the pressure supply connector P the check valve (56) is held in its opened positions such that fluid, which is flowing back from one of the control connectors P′_{A}, P′_{B} controlled by the pressure compensator (14), drains toward the return flow connector R.

2. The valve device according to claim 1, characterized in that the check valve (56) with its return stroke function acts on the control connector P′_{A} or P′_{B}.

3. The valve device according to claim 1, characterized in that the check valve (56) with its valve body (58) is supported against the valve spring (60) which tries to keep the valve body (58) on the control piston (62) of the pressure compensator (14) which is supported on the control spring (64) on the opposite end to the check valve (56).

4. The valve device according to claim 3, characterized in that when the valve body (58) adjoins the control piston (62) of the pressure compensator (14) the valve spring (60) and the control spring (64) act on the piston (62) in opposite directions.

5. The valve device according to claim 3, characterized in that the control piston (62) has through openings which are divided into individual function groups (66, 68, 70, 72) and which are each assigned to the pressure supply connector P (76), the return flow connector R (72), and the two control connectors P′_{A} (66) and P′_{B} (68).

6. The valve device according to claim 3, characterized in that the control spring (64) on its end facing away from the valve body (58) is supported on parts (74) of the housing of the pressure compensator.

7. The valve device according to claim 3, characterized in that the valve body (58) on its end side facing in the direction of the interior of the control piston (62) has a depression (80), preferably in the form of an inner cone.

8. The valve device according to claim 3, characterized in that in the unpressurized state of the pressure compensator (14) the control spring (64) moves the control piston (62) against the action of the control spring (64) into contact against the stop (94) of the housing of the pressure compensator.

9. The valve device according to claim 1, characterized in that the control spring (64) is guided in the spring chamber (16) of the housing of the pressure compensator into which the section load sensing connector (LS) discharges.

10. The valve device according to claim 3, characterized in that the maximum stroke of the valve body (58) of the check valve (56) is limited in its closing direction by a limitation means (82).
